(19) United States
(12) Patent Application Publication
(10) Pub. No.: US 2024/0075634 A1
(43) Pub. Date: Mar. 7, 2024

(54) ROBOT SYSTEM AND ROBOT WORKING METHOD

(71) Applicant: KAWASAKI JUKOGYO KABUSHIKI KAISHA, Hyogo (JP)

(72) Inventors: Masayuki KAMON, Kobe-shi, Hyogo (JP); Tomoki OKA, Kobe-shi, Hyogo (JP)

(73) Assignee: KAWASAKI JUKOGYO KABUSHIKI KAISHA, Hyogo (JP)

(21) Appl. No.: 18/268,494

(22) PCT Filed: Dec. 22, 2021
(86) PCT No.: PCT/JP2021/047585

§ 371 Date: Jun. 20, 2023

(30) Foreign Application Priority Data
Dec. 24, 2020 (JP) 2020-215817

(51) Int. Cl. B25J 13/06; B25J 5/00; G05D 1/00

(52) U.S. Cl. CPC B25J 13/06; B25J 5/007; G05D 1/0038

(57) ABSTRACT

A robot system includes a self-propelled robot, a manipulating part, a display, a circumference camera that is disposed in the self-propelled robot and images a situation around the self-propelled robot, and processing circuitry. The processing circuitry is adapted to generate a self-propelled robot simulated image, and generate a synthesized image including a circumference situation image captured by the circumference camera and the generated self-propelled robot simulated image.

### TECHNICAL FIELD

The present disclosure relates to a robot system and a robot working method.

### BACKGROUND ART

Conventionally, it is known that the circumference of an autonomously travelable robot is imaged and an operator moves the robot, while looking at the captured image (for example, see Patent Document 1).

[Reference Document(s) of Conventional Art]

[Patent Document]
[Patent Document 1] JP2013-031897A

### DESCRIPTION OF THE DISCLOSURE

### [Problem(s) to be Solved by the Disclosure]

Among the autonomously travelable robots (hereinafter, referred to as the “self-propelled robot”), some are provided with a robotic arm, and when making such a self-propelled robot travel, the robotic arm tends to interfere with surrounding objects. The above-described conventional art does not describe this problem at all.

The present disclosure is made in order to solve the above problem, and one purpose thereof is to provide a robot system and a robot working method, which are capable of avoiding that a self-propelled robot having a robotic arm interferes with a surrounding object.

### SUMMARY OF THE DISCLOSURE

In order to achieve the purpose described above, a robot system according to one aspect of the present disclosure includes a self-propelled robot including a robotic arm having one or more joints, a manipulating part that accepts operation by an operator to allow the operator to manipulate the self-propelled robot, a display visible by the operator, a circumference camera that is mounted on the self-propelled robot and images a situation around the self-propelled robot, and processing circuitry. The processing circuitry is adapted to generate a self-propelled robot simulated image that imitates every moment a posture of the self-propelled robot including a posture of the robotic arm, and generate a synthesized image displayed on the display, the synthesized image including a circumference situation image captured by the circumference camera and the generated self-propelled robot simulated image. Here, “imitate every moment” is a phrase for clarifying that a simulated image generator generates an animation (moving image) comprised of continuous self-propelled robot simulated images is generated in a simulated image generator and the self-propelled robot simulated image is an image of a moment in the animation. This phrase has no special meaning other than it. Further, a robot working method according to another aspect of the present disclosure includes operating a self-propelled robot having a robotic arm, generating a self-propelled robot simulated image that imitates every moment a posture of the self-propelled robot including a posture of the robotic arm, providing to the self-propelled robot with a circumference camera that images a situation around the self-propelled robot, generating a synthesized image including the circumference situation image captured by the circumference camera, and the self-propelled robot simulated image, and displaying the synthesized image.

[Effect of the Disclosure] The present disclosure provides the robot system and the robot

working method, which are capable of avoiding that the self-propelled robot having a robotic arm interferes with a surrounding object.

### BRIEF DESCRIPTION OF DRAWINGS

FIG. 1 is a schematic view illustrating one example of a configuration of a robot system according to one embodiment of the present disclosure.

FIG. 2 is a plan view illustrating one example of a configuration of a manipulator of FIG. 1.

FIG. 3 is a view schematically illustrating an imaging range of circumference cameras of FIG. 1.

FIG. 4 is a functional block illustrating a configuration of a control system of the robot system of FIG. 3.

FIG. 5 is a bird's eye view illustrating a synthesized image of a circumference situation image and a self-propelled robot simulated image as an image in which a self-propelled robot is looked down.

FIG. 6 is an upper view illustrating a synthesized image of the circumference situation image and the self-propelled robot simulated image as an image in which the self-propelled robot is looked from an upper viewpoint.

FIG. 7 is a first person view illustrating a synthesized image of the circumference situation image and the self-propelled robot simulated image as an image looked from the self-propelled robot.

FIG. 8 is a view illustrating a synthesized image in which a scheduled moving route of the self-propelled robot is superimposed on the circumference situation image.

FIG. 9 is a view illustrating a synthesized image in which an arm animation indicative of a change in a posture of a robotic arm of the self-propelled robot is superimposed on the self-propelled robot simulated image and the circumference situation image.

FIG. 10A is a view illustrating a frame of the arm animation indicative of the change in the posture of the robotic arm of the self-propelled robot.

FIG. 10B is a view illustrating a frame of the arm animation indicative of a change in the posture of the robotic arm of the self-propelled robot.

FIG. 10C is a view illustrating a frame of the arm animation indicative of a change in the posture of the robotic arm of the self-propelled robot.

FIG. 10D is a view illustrating a frame of the arm animation indicative of a change in the posture of the robotic arm of the self-propelled robot.

### MODES FOR CARRYING OUT THE DISCLOSURE

Hereinafter, embodiments of the present disclosure are described with reference to the drawings. Note that, below, the same reference characters are assigned to the same or corresponding elements throughout the drawings to omit redundant explanations. Further, since the following drawings are for explaining the present disclosure, elements unrelated to the present disclosure may be omitted, the dimension may not be exact because of an exaggeration etc., the elements may be simplified, and the modes of mutually-corresponding elements may not match with each other in a plurality of drawings. Moreover, the present disclosure is not limited to the following embodiments.

### Embodiment

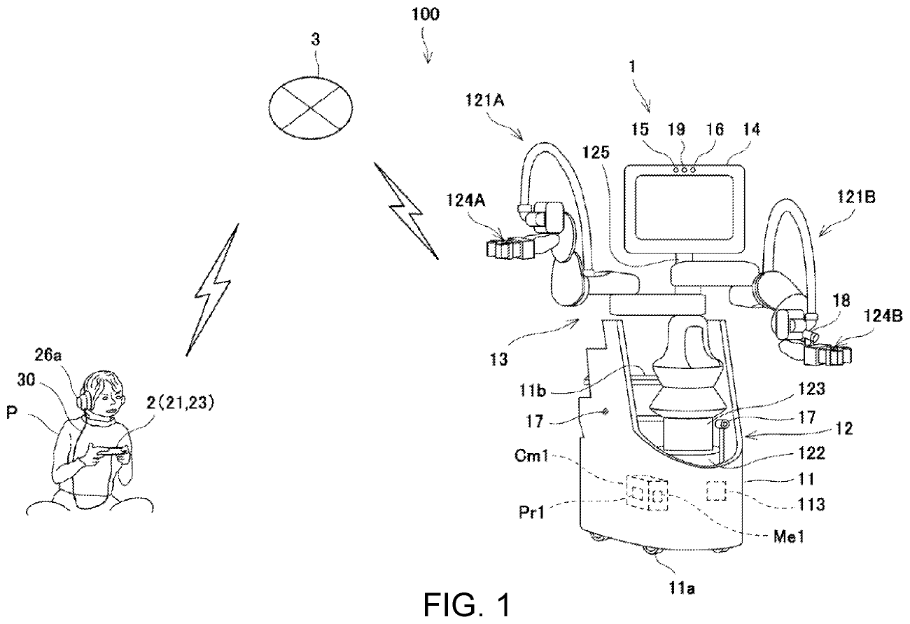

FIG. 1 is a schematic view illustrating one example of a configuration of a robot system 100 according to one embodiment of the present disclosure.

### [Hardware Configuration]

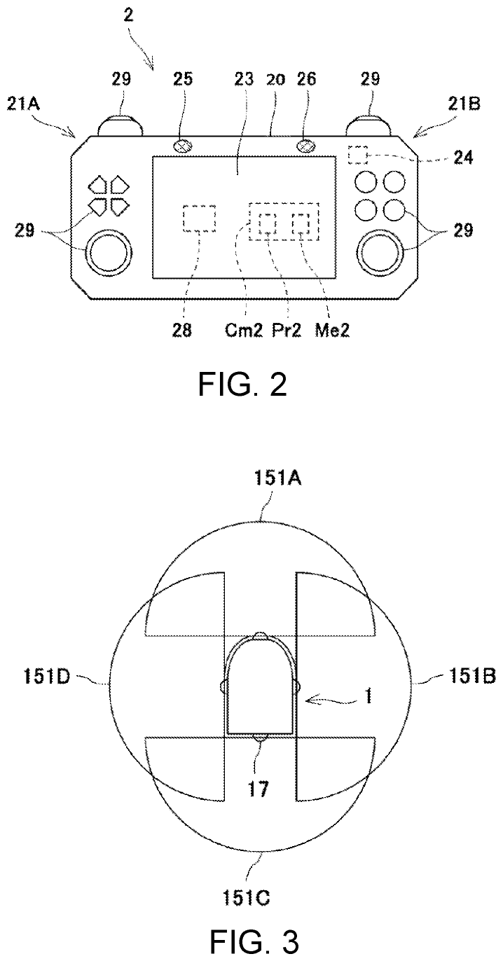

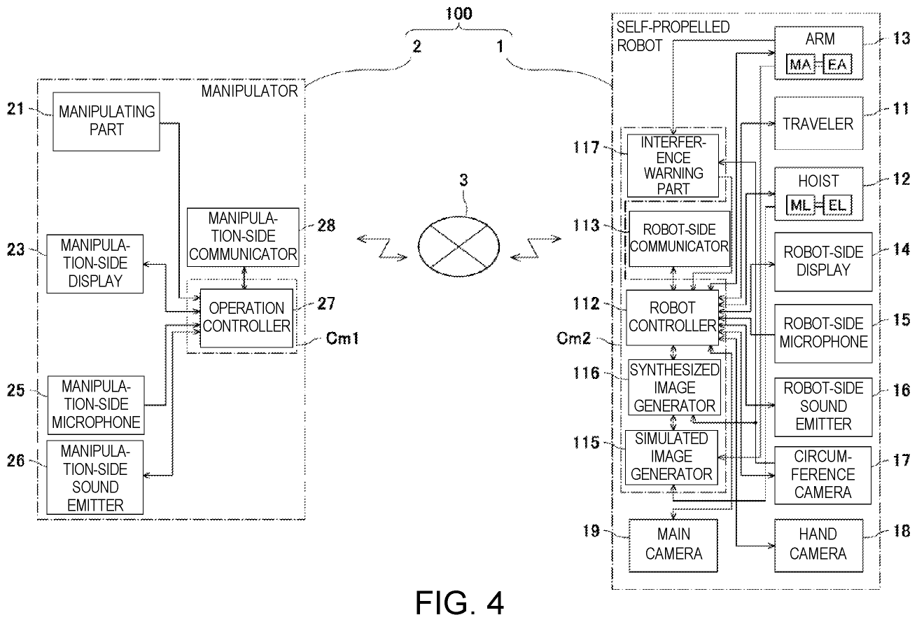

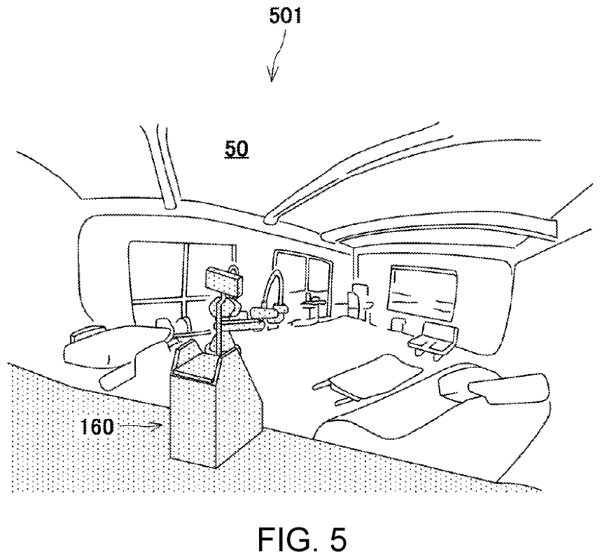

Referring to FIG. 1, a robot system 100 according to one embodiment includes a self-propelled robot 1 having robotic arms 121A and 121B, a manipulator 2 including a manipulating part 21 (21A and 21B of FIG. 2) for manipulating the self-propelled robot 1, a simulated image generator 115 (FIG. 4) which generates a self-propelled robot simulated image 160 (see FIGS. 5 to 7) which imitates every moment the posture of the self-propelled robot 1 including the postures of the robotic arms 121A and 121B, circumference cameras 17 which are provided to the self-propelled robot 1 and image the situation around the self-propelled robot 1, a synthesized image generator 116 (see FIG. 4) which generates synthesized images 501, 601, and 701 (see FIGS. 5 to 7) which include a circumference situation image 50 (see FIGS. 5 to 7) captured by the circumference cameras 17, and the self-propelled robot simulated image 160 generated by the simulated image generator 115, and a display 23 (see FIG. 2) of the above-described manipulator 2 which displays the synthesized images 501, 601, and 701 generated by the synthesized image generator 116. Below, this configuration is described in detail.

The robot system 100 of this embodiment includes the self-propelled robot 1 having a traveler 11 which is autonomously travelable and an arm 13 provided to the traveler 11, and the manipulator (console) 2.

The self-propelled robot 1 is connected with the manipulator 2 via the data communication network 3, for example. The self-propelled robot 1 may be directly connected to the manipulator 2 wiredly or wirelessly.

Below, these elements in the robot system 100 will be described in detail.

### <Application of Robot System 100>

The application of the robot system 100 is not limited in particular. Below, a case where the self-propelled robot 1 performs nursing in an individual residence is illustrated.

### <Data Communication Network 3>

The data communication network 3 may be any network as long as it enables data communications. Examples of the data communication network 3 are the Internet, a LAN (Local Area Network), a WAN (Wide Area Network), etc.

### <Self-propelled Robot 1>

Referring to FIG. 1, the self-propelled robot 1 may fundamentally be any configuration as long as it includes the traveler 11 which is autonomously travelable, and the arm (robotic arm) 13 provided on the traveler 11.

Here, the self-propelled robot 1 includes the traveler 11, a hoist (elevator) 12, and the arm 13.

The traveler 11 is comprised of a carriage, for example (hereinafter, referred to be as “the carriage 11”). The carriage 11 is provided at its base part with wheels 11a comprised of front wheels and rear wheels. One of the front wheels and the rear wheels are steering wheels, and at least one of the front wheels and the rear wheels are driving wheels. The hoist 12 is provided to a front part of the carriage, and a shelf 11b where article(s) is placed is provided to a rear part of the carriage 11.

Further, the carriage 11 includes a battery and a motor, and the carriage 11 autonomously travels by the motor driving the wheels 11a while using the battery as a power supply. The hoist 12 and the arm 13, and a robot-side display 14, a robot-side microphone 15, and a robot-side sound emitter 16, which will be described later, operate using this battery as a power supply.

The hoist 12 includes a base 122, and a hoist shaft 123 which ascends and descends with respect to the base 122. The hoist shaft 123 extends vertically, for example.

A first robotic arm 121A and a second robotic arm 121B are provided at base-end parts thereof to an upper part of the hoist shaft 123 rotatably on the center axis of the hoist shaft 123. The second robotic arm 121B is provided above the first robotic-arm 121A. Since the first robotic arm 121A and the second robotic arm 121B can interchange respective rotational positions, there is no left arm or right arm.

The first robotic arm 121A and the second robotic arm 121B are comprised of articulated robotic arms, and are provided with a hand 124A and a hand 124B at tip ends, respectively.

Although the hand 124A and the hand 124B are not limited in particular, each has a shape which can grip an object.

A circumference camera 17 is provided in front of the hoist shaft 123. In addition, the circumference cameras 17 are also provided to a right side part (illustrated by the reference character 17), a rear part (not illustrated in FIG. 1), and a left side part (not illustrated in FIG. 1) of the carriage 11. These four circumference cameras are provided at the same height. The four circumference cameras 17 are devices for an operator P to observe a situation (environment) around the self-propelled robot 1. The circumference cameras 17 will be described later in detail.

A hand camera 18 is provided to a tip-end part of the second robotic arm 121B. The hand camera 18 is a device for the operator P to observe an object to be gripped by the pair of hands 124A and 124B.

The robot-side display 14 is attached to an upper end part of the hoist shaft 123 via a support member 125. The robot-side display 14 is comprised of a liquid crystal display, for example.

The robot-side microphone 15, the robot-side sound emitter 16, and a main camera 19 are provided at suitable locations of the robot-side display 14.

The robot-side display 14, the robot-side microphone 15, the robot-side sound emitter 16, and the main camera 19 constitute a device group for the self-propelled robot 1 to have a conversation with a person (hereinafter, referred to as a “conversation partner”). The robot-side display 14 displays information (image information, text information, etc.) to be communicated to the conversation partner. The robot-side microphone 15 acquires voice of the conversation partner. The robot-side sound emitter 16 is comprised of a speaker, and emits the voice information to be communicated to the conversation partner, for example. The main camera 19 images the conversation partner.

The carriage 11 is further provided with an arithmetic circuit module Cm1 and a robot-side communicator 113. The arithmetic circuit module Cm1 is provided with a processor Pr1 and a memory Me1. The arithmetic circuit module Cm1 constitutes a robot controller (controller) 112, the simulated image generator 115, the synthesized image generator 116, and an interference warning part 117 (see FIG. 4), as will be described later. Some or all of the simulated image generator 115, the synthesized image generator 116, and the interference warning part 117 may be comprised of an arithmetic circuit module Cm2 (described later).

### <Manipulator 2>

FIG. 2 is the plan view illustrating one example of the configuration of the manipulator 2 of FIG. 1. The manipulator 2 is not limited in particular, as long as it is capable of manipulating the self-propelled robot(s) 1. As illustrated in FIG. 2, the manipulator 2 may be configured so that the left and right manipulating parts 21A and 21B are integrated, or may be comprised of a plurality of manipulating parts which are formed individually. The manipulating part is not limited in particular, as long as it is operable by an operator. Examples of the manipulating part (operating tool, operating element) are a key, a joystick, a handle, a touch panel, etc.

Alternatively, as illustrated in FIG. 2, the manipulator 2 may be configured so that the manipulating parts 21A and 21B, a manipulation-side display 23, a manipulation-side microphone 25, and a manipulation-side sound emitter 26 are integrated, or the manipulating parts 21A and 21B, the manipulation-side display 23, the manipulation-side microphone 25, and the manipulation-side sound emitter 26 may be formed separately.

Referring to FIG. 2, the manipulator 2 is provided with a main body 20. The main body 20 is formed in a thin rectangular parallelepiped box.

The left manipulating part 21A and the right manipulating part 21B are provided to a left end part and a right end part of the main body 20, respectively. The left manipulating part 21A and the right manipulating part 21B constitute a manipulating part 21. In each of the left manipulating part 21A and the right manipulating part 21B, a group of given operation keys 29 are disposed. This group of given operation keys 29 is configured similarly to a well-known operation key group of a game machine, for example. Therefore, explanation of this group of given operation keys 29 is omitted. When the operator P operates the operation keys 29 suitably with both hands, the traveler, the hoist, and the arm 13 of the self-propelled robot 1 operate according to the operation. That is, the manipulating part 21 outputs a key manipulation signal for manipulating the traveler, the hoist, and the arm 13 of the self-propelled robot 1.

The manipulation-side display 23 which is observed by the operator P is provided to a center part of an upper surface of the main body 20. The manipulation-side display 23 is a touchscreen, for example. However, the manipulation-side display 23 may not be a touchscreen, as long as it displays an image. For example, the manipulation-side display 23 may be a liquid crystal display disposed separately from the manipulator 2, or may be a head mounted display. The manipulation-side display 23 displays information necessary for the operator P to manipulate the self-propelled robot 1 (image information, text information, etc.). For example, a main image captured by the main camera 19 and a hand image captured by the hand camera 18 are suitably displayed on the manipulation-side display 23. Further, the synthesized images 501, 601, and 701 (see FIGS. 5 to 7) which will be described later are displayed on the manipulation-side display 23.

The manipulation-side microphone 25 and the manipulation-side sound emitter 26 are provided to suitable locations of the upper surface of the main body 20. The manipulation-side microphone 25 acquires voice of the conversation partner. The manipulation-side sound emitter 26 is comprised of a speaker, and emits the voice of the conversation partner acquired by the robot-side microphone 15, for example. Further, the manipulation-side sound emitter 26 may be provided with a headset 26a. A voice output terminal is provided to a suitable location of the main body 20, and when connecting a connection cord 30 of the headset 26a to the voice output terminal, an outputting part of the manipulation-side sound emitter 26 is switched from the speaker to the headset 26a so that the voice etc. of the conversation partner acquired by the robot-side microphone 15 is emitted from the headset 26a.

An arithmetic circuit module Cm2 and a manipulation-side communicator 28 are provided inside the main body 20. The arithmetic circuit module Cm2 includes a processor Pr2 and a memory Me2. The arithmetic circuit module Cm2 constitutes an operation controller 27 (see FIG. 4), as will be described later.

### <Circumference Cameras 17>

FIG. 3 is a view schematically illustrating an imaging range of the circumference cameras 17 of FIG. 1.

Referring to FIG. 3, four circumference cameras 17 are respectively provided to a front part, a right part, a rear part, and a rear part of the self-propelled robot 1. These four circumference cameras 17 are provided, in a plan view (upper view), symmetrically in the front-and-rear direction and the left-and-right direction with respect to a given center axis C of the self-propelled robot 1. Further, these four circumference cameras 17 are provided at the same height, which is about the middle of the height of self-propelled robot 1.

Each circumference cameras 17 is comprised of a wide angle camera (here, a camera with a field angle of 180 degrees). Therefore, the imaging ranges 151A-151D of the four circumference cameras 17 overlap with each other at both lateral end parts of adjacent circumference cameras 17.

Here, each circumference camera 17 is comprised of a 3D camera (three-dimensional camera). The 3D camera is a camera which is capable of acquiring not only two-dimensional information in the lateral and vertical directions (X and Y) but also information on the depth (Z). For example, the 3D camera includes a stereo type camera which utilizes parallax of a plurality of cameras, a ToF type camera utilizing a Time of Flight of light, and a structuralization lighting type camera utilizing a patternized light. Since these cameras are well-known, the detailed explanation thereof will be omitted.

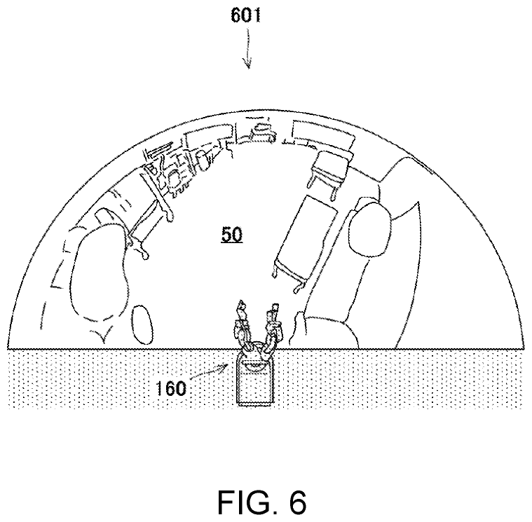

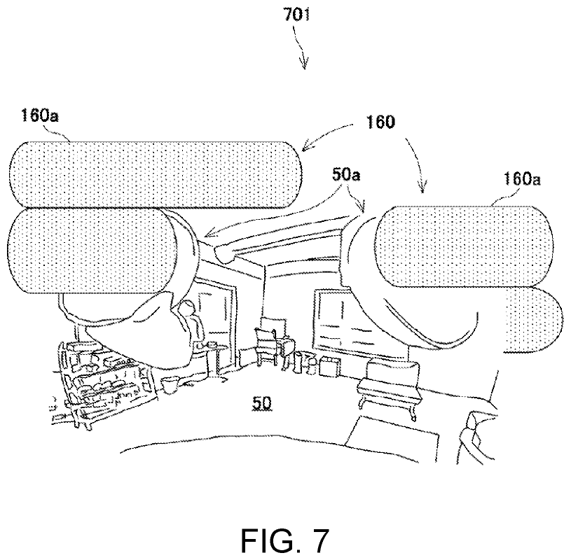

Here, by image-processing a combination of the images captured by these four circumference cameras 17, three kinds of images comprised of an image in which the circumference is looked down from a bird's eye viewpoint (hereinafter, referred to as a “bird's eye image”; see FIG. 5), an image in which the circumference is looked from an upper viewpoint (hereinafter, referred to as an “upper viewpoint image”; see FIG. 6), an image in which the circumference is looked from the self-propelled robot 1 (hereinafter, referred to as a “first person viewpoint image”; see FIG. 7) are acquired. Since the captured images of the circumference cameras 17 include the depth information, such image processing can be performed.

These images are combined with a self-propelled robot simulated image to be synthesized into a synthesized image, as will be described later.

### [Configuration of Control System]

FIG. 4 is functional block illustrating a configuration of a control system of the robot system of FIG. 3.

Below, the configuration of the control system of the robot system 100 is described dividedly into “a fundamental configuration,” “a configuration about a synthesized image” and “a configuration about interference warning.”

### <Fundamental Configuration>

### {Configuration on Manipulator 2 Side}

Referring to FIG. 4, the manipulator 2 includes the manipulating part 21, the manipulation-side display 23, the manipulation-side microphone 25, the manipulation-side sound emitter 26, the operation controller 27, and the manipulation-side communicator 28.

The manipulating part 21 outputs to the operation controller 27 a key operation signal according to operation of the operation keys 29 by the operator P.

The manipulation-side display 23 displays the image according to an image display signal inputted from the operation controller 27. Further, the manipulation-side display 23 outputs synthesized image specifying information, scheduled moving route information, and arm animation information, which will be described later in detail. Further, the manipulation-side display 23 outputs display image switch information.

The manipulation-side microphone 25 acquires voice of the operator P, and outputs it to the operation controller 27 as an operator voice signal. The manipulation-side sound emitter (interference warning informer) 26 emits conversation partner voice and interference warning voice according to a conversation partner voice signal and an interference warning voice signal which are inputted from the operation controller 27, respectively. The manipulation-side sound emitter 26 corresponds to the interference warning informer.

The operation controller 27 generates a manipulation signal according to the key operation signal inputted from the manipulating part 21, and outputs it to the manipulation-side communicator 28. This manipulation signal is generated, for example, based on assignment information on “operation of the traveler of the self-propelled robot, operation of the hoist, and operation of the arm” corresponding to “a combination of key operation signals of the group of operation keys 29” set beforehand.

Further, the operation controller 27 outputs the operator voice signal inputted from the manipulation-side microphone 25 to the manipulation-side communicator 28. Further, the operation controller 27 outputs to the manipulation-side communicator 28 the synthesized image specifying information, the scheduled moving route information, and the arm animation information, which are inputted from the manipulation-side display 23.

On the other hand, the operation controller 27 suitably generates display signals of the synthesized image, the hand image, and the main image based on the synthesized image signal, the hand image signal, and the main image signal which are inputted from the manipulation-side communicator 28, and outputs them to the manipulation-side display 23. Here, the operation controller 27 switches the display signals of the synthesized image, the hand image, and the main image according to display switch information inputted from the manipulation-side display 23.

Further, the operation controller 27 outputs the interference warning image signal to the manipulation-side display 23 based on interference warning signal inputted from the manipulation-side communicator 28, and generates the interference warning voice signal based on the interference warning signal, and outputs it to the manipulation-side microphone 25.

Further, the operation controller 27 outputs a conversation partner voice signal inputted from the manipulation-side communicator 28 to the manipulation-side sound emitter 26.

The manipulation-side communicator 28 is comprised of a communication apparatus capable of data communications. The manipulation-side communicator 28 converts into communication data (packet) the manipulation signal, the operator voice signal, and the synthesized image specifying information, the scheduled moving route information, and the arm animation information which are inputted from the operation controller 27, and transmits them to the robot-side communicator 113.

Further, the manipulation-side communicator 28 receives communication data of the synthesized image signal, the hand image signal, the main image signal, the interference warning signal, and the conversation partner voice signal from the robot-side communicator 113, converts them back to the synthesized image signal, the hand image signal, the main image signal, the interference warning signal, and the conversation partner voice signal, and outputs them to the operation controller 27.

Here, these communications are performed via the data communication network 3.

Here, the operation controller 27 is comprised of the arithmetic circuit module Cm2 having the processor Pr2 and the memory Me2. The operation controller 27 is a functional blocks realized in this arithmetic circuit module Cm2 by the processor Pr2 executing a control program stored in the memory Me2. In detail, the arithmetic circuit module Cm2 is comprised of a microcontroller, an MPU, an FPGA (Field Programmable Gate Array), a PLC (Programmable Logic Controller), etc., for example. These may be comprised of a sole arithmetic circuit module which performs a centralized control, or may be comprised of a plurality of arithmetic circuit modules which perform a distributed control.

### {Configuration on Self-propelled Robot 1 Side}

The self-propelled robot 1 includes the traveler 11, the hoist 12, the arm 13, the robot-side display 14, the robot-side microphone 15, the robot-side sound emitter 16, the circumference cameras 17, the hand camera 18, the main camera 19, the robot controller 112, the robot-side communicator 113, the simulated image generator 115, the synthesized image generator 116, and the interference warning part 117.

The robot-side communicator 113 is comprised of a communication apparatus capable of data communications. The robot-side communicator 113 receives the communication data of the manipulation signal, the operator voice signal, and the synthesized image specifying information, the scheduled moving route information, and the am animation information from the manipulation-side communicator 28, converts them back to the manipulation signal, the operator voice signal, and the synthesized image specifying information, the scheduled moving route information, and the arm animation information, and outputs them to the robot controller 112.

Further, the robot-side communicator 113 converts into communication data (packet) the synthesized image signal, the hand image signal, the main image signal, the interference warning signal, and the conversation partner voice signal which are inputted from the robot controller 112, and transmits them to the manipulation-side communicator 28.

The robot controller 112 outputs the manipulation signal inputted from the robot-side communicator 113 to the traveler 11, the hoist 12, and the arm 13.

Further, the robot controller 112 outputs to the synthesized image generator 116 the synthesized image specifying information, the scheduled moving route information, and the arm animation information which are inputted from the robot-side communicator 113.

Further, the robot controller 112 suitably generates the image display signal, and outputs it to the robot-side display 14.

Further, the robot controller 112 outputs the operator voice signal inputted from the robot-side communicator 113 to the robot-side sound emitter 16. In this case, for example, the robot controller 112 may display on the robot-side display 14 an image of a person wearing a uniform according to a given work site (for example, an illustration image), and may convert the operator voice signal into a signal of voice which matches with the given person (for example, voice which corresponds to the sex of the employee, and is soft).

Further, the robot controller 112 outputs to the robot-side communicator 113 the synthesized image signal inputted from the synthesized image generator 116, the hand image signal inputted from the hand camera 18, and the main image signal inputted from the main camera 19.

The traveler 11, the hoist 12, and the arm 13 operate according to the manipulation signal inputted from the robot controller 112.

The robot-side display 14 displays an image according to the image display signal inputted from the robot controller 112.

The robot-side microphone 15 acquires the voice of the conversation partner (for example, a customer), and outputs it to the robot controller 112 as the conversation partner voice signal.

The robot-side sound emitter 16 emits the voice according to the operator voice signal inputted from the robot controller 112. The robot-side sound emitter 16 is comprised of a speaker, for example.

The circumference cameras 17 image the situation (environment) around the self-propelled robot 1, and output it to the synthesized image generator 116 and the interference warning part 117 s the circumference situation image signal.

The hand camera 18 images the environment of the hand of the second robotic arm 121B, and outputs it to the robot controller 112 as the hand image. One example of the environment of the hand of the second robotic arm 121B is an object which the hand 124B is about to grip.

The main camera 19 images the field of view equivalent to a field of view of a standing person, and outputs it to the robot controller 112 and the association part 111 as the main image. When the self-propelled robot 1 faces the conversation partner, an image of the conversation partner exists in the main image.

Here, the robot controller 112, the simulated image generator 115, the synthesized image generator 116, and the interference warning part 117 are comprised of the arithmetic circuit module Cm1 having the processor Pr1 and the memory Me1. The processor Pr1 is one example of processing circuitry. The simulated image generator 115, the synthesized image generator 116, and the interference warning part 117 may also be referred to as the simulated image generation circuit, the synthesized image generation circuit, and the interference warning circuit, respectively. The robot controller 112, the simulated image generator 115, the synthesized image generator 116, and the interference warning part 117 are functional blocks realized in this arithmetic circuit module Cm1 by the processor Pr1 executing a control program stored in the memory Me1. In detail, this arithmetic circuit module Cm1 is comprised of a microcontroller, an MPU, an FPGA (Field Programmable Gate Array), a PLC (Programmable Logic Controller), etc., for example. These may be comprised of a sole arithmetic circuit module which performs a centralized control, or may be comprised of a plurality of arithmetic circuit modules which perform a distributed control.

The functions of the elements disclosed herein may be performed using circuitry or processing circuitry including a general-purpose processor, a dedicated processor, an integrated circuit, ASIC (Application Specific Integrated Circuits), conventional circuitry, and/or a combination thereof, which are configured or programmed to execute the disclosed functions. Since the processor includes transistors or other circuitry, it is considered to be processing circuitry or circuitry. In the present disclosure, “unit” or “part” is hardware which performs the listed function, or hardware programmed to perform the listed function. The hardware may be hardware disclosed herein, or may be other known hardware programmed or configured to perform the listed function. When the hardware is a processor considered to be a kind of circuitry, the “unit” or the “part” is a combination of hardware and software, and the software is used for the configuration of the hardware and/or the processor.

<Configuration about Synthesized Image>

Below, a configuration about the synthesized image is described for each component in order.

### {Simulated Image Generator 115}

Referring to FIGS. 1 and 4, each joint of the first and second robotic arms 121A and 121B of the self-propelled robot 1 is driven by a motor MA (see FIG. 4), and therefore, the postures change. Each joint is provided with a rotation angle detector EA (see FIG. 4) which detects a rotation angle of the motor MA. This rotation angle detector EA is comprised of an encoder, for example. Therefore, the postures of the first and second robotic arms 121A and 121B can be acquired on real time by utilizing the rotation angle of the motor MA at each joint.

The simulated image generator 115 generates an am image which imitates every moment the postures of the first and second robotic arms 121A and 121B based on the rotation angle outputted from the rotation angle detector EA at each joint of the first and second robotic arms 121A and 121B.

The hoist 12 of the self-propelled robot 1 is provided with a rotation angle detector EL (see FIG. 4) which detects a rotation angle of a motor ML (see FIG. 4) which raises and lowers the hoist shaft 123. This rotation angle detector EL is comprised of an encoder, for example. Therefore, the posture of the hoist 12 can be acquired on real time by utilizing the rotation angle of the motor ML. The simulated image generator 115 generates a hoist image which imitates every moment the posture of the hoist 12 based on the rotation angle outputted from the rotation angle detector EL.

Then, the simulated image generator 115 generates the self-propelled robot simulated image 160 (see FIGS. 5 to 7) which imitates every moment the posture of the self-propelled robot 1 including the postures of the first and second robotic arms 121A and 121B by synthesizing the arm image and the hoist image described above. Then, it outputs the self-propelled robot simulated image 160 to the synthesized image generator 116. CAD data of the self-propelled robot 1 is used for generating the self-propelled robot simulated image 160, for example. The self-propelled robot simulated image 160 may be simplified, as long as this simplification does not greatly spoil the clarity of the posture of the self-propelled robot 1.

In detail, the simulated image generator 115 generates, according to the synthesized image specifying information inputted from the synthesized image generator 116, any one of three kinds of self-propelled robot simulated images, comprised of a self-propelled robot simulated image 160 in which the self-propelled robot 1 is looked down from a bird eye viewpoint, a self-propelled robot simulated image 160 in which the self-propelled robot 1 is looked from above, and a self-propelled robot simulated image 160 comprised of an arm imitation part 160a (described later) which is disposed at an edge part (here, a left end part and a right end part of an upper end part) of the circumference situation image 50 which is looked from the self-propelled robot 1.

### {Synthesized Image Generator 116}

As described above, the synthesized image generator 116 generates the three kinds of images, the bird's eye image, the upper viewpoint image, and the first person viewpoint image, by image-processing the combination of the captured images inputted from the four circumference cameras 17. Then, it combines these images with the self-propelled robot simulated image inputted from the simulated image generator 115 to obtain the synthesized image.

In this case, since the self-propelled robot simulated image includes three-dimensional information, the self-propelled robot simulated image can be precisely converted into the images of the three kinds of viewpoint, images of the bird's eye image, the upper viewpoint image, and the first person viewpoint image.

FIG. 5 is a bird's eye view illustrating the synthesized image 501 of the circumference situation image 50 and the self-propelled robot simulated image 160 as an image in which the self-propelled robot is looked down from a bird's eye viewpoint. FIG. 6 is an upper view illustrating the synthesized image 601 of the circumference situation image 50 and the self-propelled robot simulated image 160 as an image in which the self-propelled robot is looked from an upper viewpoint. FIG. 7 is a first person view illustrating the synthesized image 701 of the circumference situation image 50 and the self-propelled robot simulated image 160 as an image looked from the self-propelled robot. FIGS. 5 to 7 illustrate a situation in which the self-propelled robot 1 moves inside an individual residence for nursing, for example.

Referring to FIG. 5, in the synthesized image 501 of the bird's eye viewpoint, the self-propelled robot simulated image 160 in which the self-propelled robot 1 is looked down from the bird's eye viewpoint is disposed in front of the circumference situation image 50 in which the self-propelled robot 1 is looked down from the bird's eye viewpoint. Since the circumference situation image 50 is imaged by the wide-angle circumference cameras 17, it is distorted.

Referring to FIG. 6, in the synthesized image 601 of the upper viewpoint, the self-propelled robot simulated image 160 in which the self-propelled robot 1 is looked from above is disposed in front of the circumference situation image 50 in which the self-propelled robot 1 is looked from the upper viewpoint.

Referring to FIG. 7, in the synthesized image 701 of the first person viewpoint, the arm imitation part 160a which imitates a part of each of the robotic arms 121A and 121B of the self-propelled robot 1 is disposed at an edge part (here, a left end part and a right end part of an upper end part) of the circumference situation image 50 which is looked from the self-propelled robot 1, as the self-propelled robot simulated image 160. In detail, tip-end parts 50a of the robotic arms 121A and 121B are displayed in the left end part and the right end part of the upper end part of the circumference situation image 50. The arm imitation parts 160a are displayed so that their tip-end parts are connected with the tip-end parts 50a of the robotic arms 121A and 121B displayed in the circumference situation image 50.

Note that, here, since the circumference cameras 17 are disposed below and forward of the robotic arms 121A and 121B, parts other than the tip-end parts of the robotic arms 121A and 121B are not displayed in the circumference situation image. Therefore, as described above, the arm imitation parts 160a of the self-propelled robot simulated images 160 are disposed in the left end part and the right end part of the upper end part of the circumference situation image 50 so that they are connected with the tip-end parts 50a of the robotic arms 121A and 121B displayed in the circumference situation image 50. In this case, if an imitation part of a base-end part (it exists behind the circumference camera 17) of the robotic arm is tried to be displayed in the self-propelled robot simulated image 160, it is displayed in the center part of the circumference situation image 50, and therefore, the important center part of the circumference situation image 50 will not be displayed. Therefore, the imitation part of the robotic arm in the self-propelled robot simulated image 160 is dividedly displayed in the left end part and the right end part of the upper end part of the circumference situation image 50, without displaying a part corresponding to the base-end part of the robotic arm, thereby displaying the center part of the circumference situation image 50. Note that the self-propelled robot simulated image 160 may be generated by dramatically schematizing (simplifying) the imitation part of the robotic arm in the self-propelled robot simulated image 160, and, for example, disposing the part corresponding to the base-end part of the robotic arm at an upper part or a lower part of the circumference image 50.

The synthesized image generator 116 generates the three kinds of synthesized images 501, 601, and 701 by the above-described synthesization. In detail, when the synthesized image specifying information is inputted from the robot controller 112, the synthesized image generator 116 outputs this synthesized image specifying information to the simulated image generator 115, generates the synthesized image which is specified among the three kinds of synthesized images 501, 601, and 701, and outputs it to the robot controller 112.

<Configuration about Scheduled Moving Route 802 of Self-propelled Robot 1>

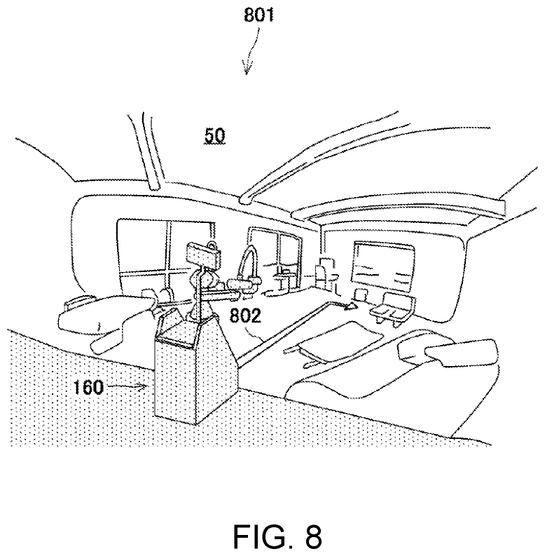

FIG. 8 is a view illustrating a synthesized image in which a scheduled moving route 802 of the self-propelled robot 1 is superimposed on the circumference situation image 50.

Referring to FIG. 8, in a synthesized image 801, the scheduled moving route 802 of the self-propelled robot 1 is illustrated so as to be superimposed on the circumference situation image 50. The scheduled moving route 802 is illustrated so as to extend from the self-propelled robot simulated image 160 to a target position.

When the scheduled moving route information is received from the robot controller 112, the synthesized image generator 116 displays the scheduled moving route 802 of the self-propelled robot 1 so as to be superimposed on the circumference situation image 50. In this case, for example, the synthesized image generator 116 generates the scheduled moving route 802 based on the target position of the self-propelled robot 1 indicated in the scheduled moving route information, and the current position of the self-propelled robot 1. Note that the current position of the self-propelled robot 1 is acquired, for example, from the rotation angle of the motor which drives the traveler of the self-propelled robot 1.

Further, the synthesized image generator 116 may generate the scheduled moving route 802 based on the manipulation signal received by the robot controller 112. In this case, a target value (command value) of moving (traveling) of the self-propelled robot 1 in the manipulation signal becomes the target position of the self-propelled robot 1. Moreover, the scheduled moving route information does not include the moving target position of the self-propelled robot 1. Note that, although FIG. 8 illustrates the scheduled moving route 802 in the synthesized image of the bird's eye viewpoint, the scheduled moving route 802 can be displayed similarly in the synthesized image of the upper viewpoint or the first person viewpoint.

<Configuration about Arm Animation>

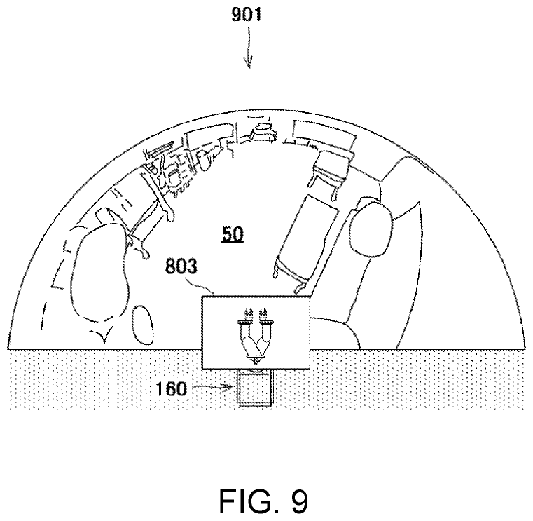

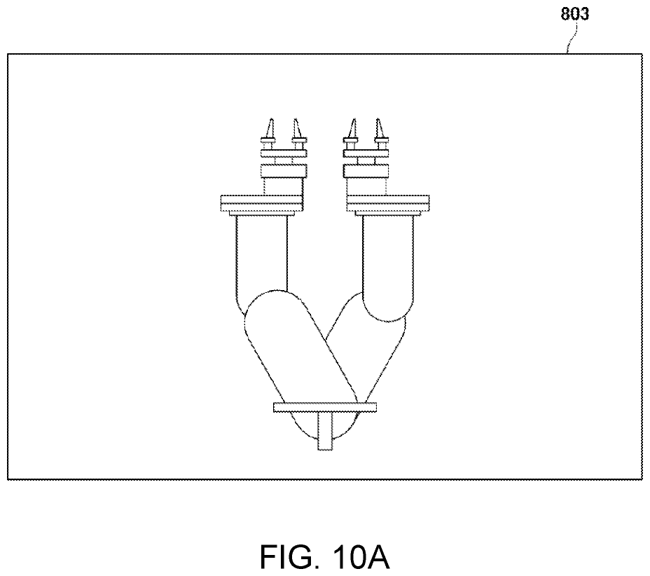

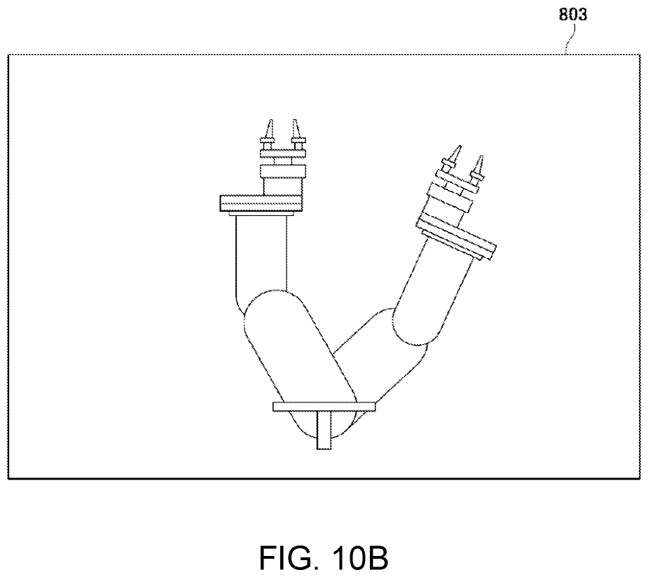

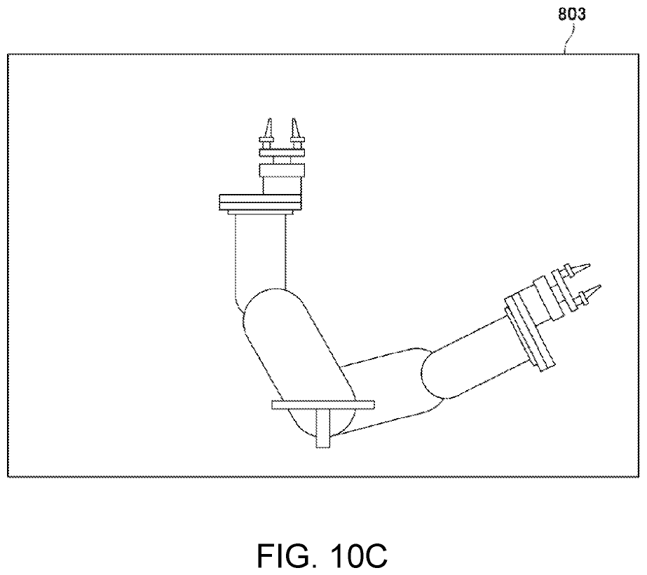

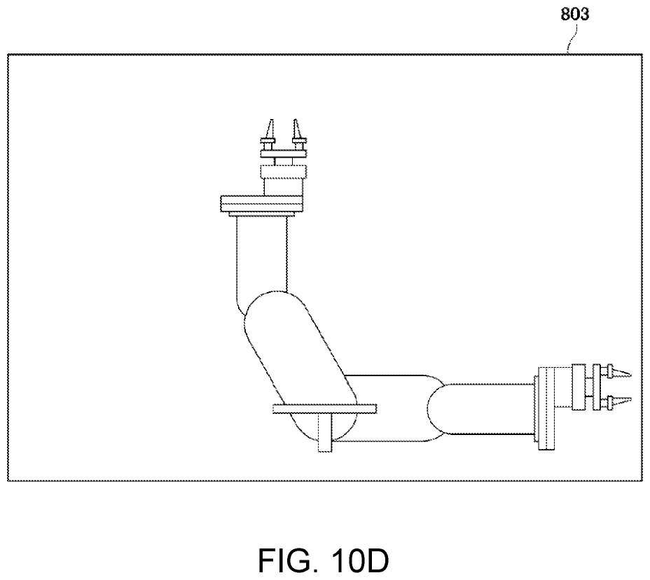

FIG. 9 is a view illustrating a synthesized image 901 in which an arm animation (moving image) 803 indicative of a change in the postures of the robotic arms 121A and 121B of the self-propelled robot 1 is superimposed on the self-propelled robot simulated image 160 and the circumference situation image 50. FIGS. 10A to 10D are views illustrating frames of the arm animation 803 indicative of the change in the posture of the robotic arm 121 of the self-propelled robot 1. In FIGS. 10A to 10D, the robotic arms 121A and 121B are displayed in a simplified fashion. Illustration of the U-shaped cable is also omitted. The robotic arm in the arm animation 803 may be displayed faithfully to the actual robotic arms 121A and 121B, or may be simplified more.

Referring to FIG. 9, when the arm animation information is received from the robot controller 112, the synthesized image generator 116 displays the arm animation 803 so as to be superimposed on the self-propelled robot simulated image 160 and the circumference situation image 50. Note that the arm animation 803 may be displayed so as to be superimposed only on the self-propelled robot simulated image 160, or only on the circumference situation image 50. As illustrated in FIGS. 10A to 10D, this arm animation 803 indicates a situation of the change in the robotic arms 121A and 121B.

In this case, the synthesized image generator 116 generates the arm animation 803, for example, based on the target positions (postures) of the robotic arms 121A and 121B indicated in the am animation information, and the current positions (postures) of the robotic arms 121A and 121B. Note that the current position of the self-propelled robot 1 is acquired from the rotation angle outputted from the rotation angle detector EA at each joint of the first and second robotic arms 121A and 121B as described above.

Further, the synthesized image generator 116 may generate the scheduled moving route 802 based on the manipulation signal received by the robot controller 112. In this case, position command values of the robotic arms 121A and 121B in the manipulation signal become the target positions of the robotic arms 121A and 121B. Further, the arm animation information does not include the target positions of the robotic arms 121A and 121B. Note that, although FIG. 9 illustrates the arm animation 803 in the synthesized image of the upper viewpoint, the arm animation 803 can be displayed similarly in the synthesized image of the bird's eye viewpoint or the first person viewpoint.

<Configuration about Interference Warning>

The interference warning part 117 generates the interference warning signal based on the circumference situation image inputted from the circumference cameras 17, and the posture of the self-propelled robot 1, and outputs it to the robot controller 112.

The circumference situation image includes three-dimensional information. The interference warning part 117 first extracts from the circumference situation image, by image processing, a three-dimensional contour of an object which exists in the both lateral directions and the traveling direction of the self-propelled robot 1 (hereinafter, simply referred to as “the object”). Next, the interference warning part 117 acquires a distance between the extracted object and the self-propelled robot 1 by utilizing the depth information on the circumference situation image. Next, the interference warning part 117 determines whether the self-propelled robot 1 interferes with the object, for example, based on the distance and a direction of the extracted object from the self-propelled robot 1. When determined that the self-propelled robot 1 interferes with the object, the interference warning part 117 outputs the interference warning signal to the robot controller 112.

Then, this interference warning signal is sent to the operation controller 27 via the robot controller 112, the robot-side communicator 113, and the manipulation-side communicator 28. Then, the operation controller 27 displays an interference warning indication on the manipulation-side display 23 and makes the manipulation-side sound emitter 26 emit interference warning voice, according to the interference warning signal.

### [Operation]

Next, operation of the robot system 100 configured as above (robot working method) is described.

Referring to FIGS. 1 and 2, the operator P operates the manipulating part 21 of the manipulator 2 to make the self-propelled robot 1 travel inside the individual residence for nursing. During the travel, he/she makes the self-propelled robot 1 perform works required for nursing. Here, the operator P makes the self-propelled robot 1 perform the works, while mainly looking at the main image and the hand image which are displayed on the manipulation-side display 23 of the manipulator 2. Here, the operator P can switch the display of the main image, the hand image, and the synthesized image on the manipulation-side display 23 by touching the manipulation-side display 23. Further, as needed, the operator P has a conversation with a care recipient or a personnel involved in nursing of the care recipient, by utilizing the manipulation-side microphone 25 and the manipulation-side sound emitter 26 of the manipulator 2, and the robot-side display 14, the robot-side microphone 15, and the robot-side sound emitter 16 of the self-propelled robot 1.

Further, when making the self-propelled robot 1 travel, the operator P touches the manipulation-side display 23 to display desired synthesized images 501, 601, and 701 on the manipulation-side display 23. As the self-propelled robot 1 advances, the circumference situation image 50 changes every moment in the synthesized images 501, 601, and 701, and as the postures of the arm 13 and the hoist 12 change for the work, the self-propelled robot simulated image 160 changes every moment accordingly. In this case, especially, since the posture of the arm changes every moment in the self-propelled robot simulated image 160, the operator P can make the self-propelled robot 1 travel so that it does not interfere with surrounding objects.

Further, in this case, when the operator P touches the manipulation-side display 23 to input the scheduled moving route information including the moving target position of the self-propelled robot 1, the synthesized image 801 including the scheduled moving route 802 of the self-propelled robot 1 is displayed on the manipulation-side display 23. The operator P can make the self-propelled robot 1 travel precisely, while referring to the scheduled moving route 802.

When the operator P touches the manipulation-side display 23 to input the arm animation information including the target positions of the robotic arms 121A and 121B of the self-propelled robot 1, the synthesized image 901 including the am animation 803 is displayed on the manipulation-side display 23. The operator P can suitably perform a work by operating the robotic arms 121A and 121B precisely, while referring to the arm animation 803.

Further, when the self-propelled robot 1 nearly interferes with a surrounding object while traveling, the interference warning indication is displayed on the manipulation-side display 23, and the interference warning voice is emitted from the manipulation-side sound emitter 26. The operator P notices the possibility of interference by the interference warning indication and the interference warning voice, and he/she then operates the manipulator 2 to make the self-propelled robot 1 perform a necessary interference avoiding maneuver.

### Other Embodiments

In the above embodiments, the simulated image generator 115 may be configured to generate the self-propelled robot simulated image 160 from which the posture change of the hoist 12 is omitted.

As described above, according to one embodiment of the present disclosure, it is avoidable that the self-propelled robot 1 having the robotic arms 121A and 121B interferes with the surrounding objects.

Further, the robotic arms 121A and 121B have the rotation angle detector EA which detects the rotation angle of the motor MA which drives each joint, and the simulated image generator 116 is configured to generate the self-propelled robot simulated image 160 based on at least the rotation angle detected by the rotation angle detector EA corresponding to each joint of the robotic arms 121A and 121B.

Therefore, since the self-propelled robot simulated image 160 is generated based on the rotation angle detected by the rotation angle detector EA corresponding to each joint of the robotic arms 121A and 121B, the postures of the robotic arms 121A and 121B in the self-propelled robot simulated image 160 become the exact posture on real time. As a result, it can be avoided more precisely that the self-propelled robot 1 having the robotic arms 121A and 121B interferes with the surrounding object.

Further, the robot system 100 is configured so that, when the synthesized image generator 116 generates the synthesized image 701 of the first person viewpoint which is looked from the self-propelled robot 1, the simulated image generator 115 generates the self-propelled robot simulated image 160 so that the arm imitation part 160a which imitates at least a part of the portion of the robotic arms 121A and 121B of the self-propelled robot 1 in the self-propelled robot simulated image 160, which are not displayed in the circumference situation image 50, are connected with the part 50a of the robotic am displayed in the circumference situation image, and the synthesized image generator 116 generates the synthesized image 50 of the first person viewpoint so that the arm imitation part 160a of the generated self-propelled robot simulated image 160 is connected with the part 50a of the robotic arm displayed in the circumference situation image 50.

Therefore, even in the synthesized image 701 of the first person viewpoint which uses the circumference situation images 50 and which does not display the entire robotic arms 121A and 121B of the self-propelled robot 1 based on the layout of the circumference cameras 17, the self-propelled robot simulated image 160 including the arm imitation part 160a which imitates at least a part of the portion of the robotic arms 121A and 121B of the self-propelled robot 1, which is not displayed in the circumference situation image 50, can be generated suitably.

Further, the synthesized image generator 116 is configured to generate the synthesized image 801 in which the scheduled moving route 802 of the self-propelled robot 1 is displayed so as to be superimposed on the circumference situation image 50.

Therefore, the operator P can make the self-propelled robot travel precisely, while looking at the scheduled moving route 802 of the self-propelled robot 1.

Further, the synthesized image generator 116 is configured to generate the synthesized image 601 in which the arm animation 803 indicative of the change in the postures of the robotic arms 121A and 121B of the self-propelled robot 1 is displayed so as to be superimposed on at least one of the circumference situation image 50 and the self-propelled robot simulated image 160. Therefore, the operator P can operate the operating arms 121A and 121B precisely to make the robot work, while looking at the animation 803.

Further, the robot system 100 further includes the interference warning part 117 which determines whether the robotic arms 121A and 121B interfere with the object around the self-propelled robot 1 based on the circumference situation image captured by the circumference cameras 17 and the posture of the self-propelled robot 1, and when determined that the interference occurs, outputs the interference warning signal.

Therefore, the interference of the robotic arms 121A and 121B with the object around the self-propelled robot 1 can be avoided by utilizing the interference warning signal.

Further, the display 23 is configured to display the image indicative of the interference warning according to the interference warning signal outputted from the interference warning part 116.

Therefore, the operator P can know the possibility of the interference of the robotic arms 121A and 121B with the object around the self-propelled robot 1 by looking at the indication of the display 23.

The robot system 100 is further provided with the interference warning informer 26 which is provided separately from the display 23 and informs the interference warning according to the interference warning signal outputted from the interference warning part 116.

Therefore, the operator P can know the possibility of the interference of the robotic arms 121A and 121B with the object around the self-propelled robot 1, as informed by the interference warning informer 26.

It is apparent for the person skilled in the art that many improvements and other embodiments are possible from the above description. Therefore, the above description is to be interpreted only as illustration.

The functionality of the elements disclosed herein may be implemented using circuitry or processing circuitry which includes general-purpose processors, special-purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the present disclosure, the circuitry, units, or means are hardware that carry out or are programmed to perform the recited functionality. The hardware may be any hardware disclosed herein or other known hardware which is programmed or configured to carry out the recited functionality. When the hardware is a processor which may be considered a type of circuitry, the circuitry, means, or units are a combination of hardware and software, the software being used to configure the hardware and/or processor.

A robot system according to one aspect of the present disclosure includes a self-propelled robot including a robotic arm having one or more joints, a manipulating part that accepts operation by an operator to allow the operator to manipulate the self-propelled robot, a display visible by the operator, a circumference camera that is mounted on the self-propelled robot and images a situation around the self-propelled robot, and processing circuitry. The processing circuitry is adapted to generate a self-propelled robot simulated image that imitates every moment a posture of the self-propelled robot including a posture of the robotic arm, and generate a synthesized image displayed on the display, the synthesized image including a circumference situation image captured by the circumference camera and the generated self-propelled robot simulated image.

According to this configuration, since the display displays the self-propelled robot simulated image which imitates every moment the posture of the self-propelled robot including the posture of the robotic arm, together with the circumference situation image captured by the circumference camera, the operator can operate the manipulating part to avoid that the self-propelled robot having the robotic am interferes with a surrounding object, while looking at the display.

The robotic am may include one or more motors that drive the one or more joints, respectively, and one or more rotation angle detectors that detect rotation angle(s) of the one or more motors, respectively. The processing circuitry may generate the self-propelled robot simulated image based on at least the rotation angle(s) detected by the one or more rotation angle detectors.

In the above-described robot system, when the processing circuitry generates the synthesized image of a first person viewpoint that is looked from the self-propelled robot, the processing circuitry may generate the self-propelled robot simulated image so that an arm imitation part that imitates at least a part of a portion of the robotic arm of the self-propelled robot, that is not displayed in the circumference situation image, is connected with a part of the robotic arm displayed in the circumference situation image, and the processing circuitry may generate the synthesized image of the first person viewpoint so that the arm imitation part in the generated self-propelled robot simulated image is connected with the part of the robotic arm displayed in the circumference situation image.

In the above-described robot system, the processing circuitry may generate the synthesized image in which a scheduled moving route of the self-propelled robot is superimposed on the circumference situation image.

In the above-described robot system, the processing circuitry may generate the synthesized image in which an arm animation indicative of a change in the posture of the robotic arm of the self-propelled robot is displayed so as to be superimposed on the circumference situation image or the self-propelled robot simulated image.

In the above-described robot system, the processing circuitry may determine whether the robotic arm interferes with an object around the self-propelled robot based on the circumference situation image captured by the circumference camera, and the posture of the self-propelled robot, and when the processing circuitry determines that the robotic arm interferes with the object, the processing circuitry may output an interference warning signal.

In the above-described robot system, the display may display an image indicative of an interference warning according to the outputted interference warning signal.

The above-described robot system may further include an interference warning informer that is disposed separately from the display and informs an interference warning according to the outputted interference warning signal.

A robot working method according to one aspect of the present disclosure includes operating a self-propelled robot having a robotic arm, generating a self-propelled robot simulated image that imitates every moment a posture of the self-propelled robot including a posture of the robotic arm, providing to the self-propelled robot with a circumference camera that images a situation around the self-propelled robot, generating a synthesized image including the circumference situation image captured by the circumference camera, and the self-propelled robot simulated image, and displaying the synthesized image.

According to this configuration, it can be avoided that the self-propelled robot having a robotic am interferes with a surrounding object.

1. A robot system, comprising:
a self-propelled robot including a robotic arm having one or more joints;
a manipulating part that accepts operation by an operator to allow the operator to manipulate the self-propelled robot;
a display visible by the operator;
a circumference camera that is mounted on the self-propelled robot and images a situation around the self-propelled robot; and
processing circuitry, the processing circuitry being adapted to:
generate a self-propelled robot simulated image that imitates every moment a posture of the self-propelled robot including a posture of the robotic arm; and
generate a synthesized image displayed on the display, the synthesized image including a circumference situation image captured by the circumference camera and the generated self-propelled robot simulated image.

2. The robot system of claim 1, wherein the robotic arm includes one or more motors that drive the one or more joints, respectively, and one or more rotation angle detectors that detect rotation angle(s) of the one or more motors, respectively, and
wherein the processing circuitry generates the self-propelled robot simulated image based on at least the rotation angle(s) detected by the one or more rotation angle detectors.

3. The robot system of claim 1, wherein,
when the processing circuitry generates the synthesized image of a first person viewpoint that is looked from the self-propelled robot,
the processing circuitry generates the self-propelled robot simulated image so that an arm imitation part that imitates at least a part of a portion of the robotic arm of the self-propelled robot, that is not displayed in the circumference situation image, is connected with a part of the robotic arm displayed in the circumference situation image, and
the processing circuitry generates the synthesized image of the first person viewpoint so that the arm imitation part in the generated self-propelled robot simulated image is connected with the part of the robotic arm displayed in the circumference situation image.

4. The robot system of claim 1, wherein the processing circuitry generates the synthesized image in which a scheduled moving route of the self-propelled robot is superimposed on the circumference situation image.

5. The robot system of claim 1, wherein the processing circuitry generates the synthesized image in which an arm animation indicative of a change in the posture of the robotic arm of the self-propelled robot is displayed so as to be superimposed on the circumference situation image or the self-propelled robot simulated image.

6. The robot system of claim 1, wherein the processing circuitry determines whether the robotic arm interferes with an object around the self-propelled robot based on the circumference situation image captured by the circumference camera, and the posture of the self-propelled robot, and when the processing circuitry determines that the robotic arm interferes with the object, the processing circuitry outputs an interference warning signal.

7. The robot system of claim 6, wherein the display displays an image indicative of an interference warning according to the outputted interference warning signal.

8. The robot system of claim 6, further comprising an interference warning informer that is disposed separately from the display and informs an interference warning according to the outputted interference warning signal.

9. A robot working method, comprising:
operating a self-propelled robot having a robotic arm;
generating a self-propelled robot simulated image that imitates every moment a posture of the self-propelled robot including a posture of the robotic arm;
providing to the self-propelled robot with a circumference camera that images a situation around the self-propelled robot;
generating a synthesized image including the circumference situation image captured by the circumference camera, and the self-propelled robot simulated image; and
displaying the synthesized image.
